(19) United States
(12) Patent Application Publication
(10) Pub. No.: US 2015/0012274 A1
(43) Pub. Date: Jan. 8, 2015

(54) APPARATUS AND METHOD FOR EXTRACTING FEATURE FOR SPEECH RECOGNITION

(71) Applicant: ELECTRONICS AND TELECOMMUNICATIONS RESEARCH INSTITUTE, Daejeon (KR)

(72) Inventors: Sung-Joo LEE, Daejeon (KR); Byung-Ok Kang, Daejeon (KR); Hoon Chung, Daejeon (KR); Ho-Young Jung, Daejeon (KR); Hwa-Jeon Song, Daejeon (KR); Yoo-Rhee Oh, Daejeon (KR); Yun-Keun Lee, Daejeon (KR)

(73) Assignee: ELECTRONICS AND TELECOMMUNICATIONS RESEARCH INSTITUTE, Daejeon (KR)

(21) Appl. No.: 14/278,485

(22) Filed: May 15, 2014

(30) Foreign Application Priority Data
Jul. 3, 2013 (KR) 10-2013-0077494

(51) Int. Cl. G10L 15/02; G10L 25/06

(52) U.S. Cl. CPC G10L 15/02; G10L 25/06
USPC 704/237; 704/251

(57) ABSTRACT

An apparatus for extracting features for speech recognition in accordance with the present invention includes: a frame forming portion configured to separate input speech signals in frame units having a prescribed size; a static feature extracting portion configured to extract a static feature vector for each frame of the speech signals; a dynamic feature extracting portion configured to extract a dynamic feature vector representing a temporal variance of the extracted static feature vector by use of a basis function or a basis vector; and a feature vector combining portion configured to combine the extracted static feature vector with the extracted dynamic feature vector to configure a feature vector stream.

### CROSS REFERENCE TO RELATED APPLICATION

This application claims the benefit of Korean Patent Application No. 10-2013-0077494, filed on Jul. 3, 2013, entitled “Apparatus and method for extracting feature for speech recognition”, which is hereby incorporated by reference in its entirety into this application.

### BACKGROUND

1. Technical Field

The present invention relates to speech recognition, more specifically to an apparatus and a method for extracting features for speech recognition.

2. Background Art

An ultimate performance in a speech recognition technology highly depends on the performance of extracting features of a speech. Nowadays, a feature vector combined with a static feature and a dynamic feature is generally used in the methods for extracting features for automatic speech recognition. In the conventional methods for extracting static features, delta or double-delta is used in order to represent a time variant characteristic of cepstral coefficients, whereas the delta represents a velocity feature and the double-delta represents an acceleration feature. These dynamic features have contributed to improved performances of speech recognition by applying a time variant characteristic of speech signals to HMM (hidden markov model) based speech recognition systems. However, these methods for extracting dynamic features simplify and represent the amount of temporal variance of the speech signals linearly, thereby not being able to represent the dynamic variance of the speech signals.

FIG. 1 shows a structure of a conventional apparatus for extracting features for speech recognition. An analog digital converter 110 transforms analog speech signals to digital signals. A frame formation portion 120 divides consecutive digital speech signals into frame units having the frame shift size of 10 ms and the frame size of 20˜25 ms. The frame size is based on quasi-stationary assumption that a periodic characteristic of speech is statistically stationary within 20˜25 ms. The apparatus for extracting features analyzes the characteristic of the speech signal based on the separated frame signal and extracts the features of the speech necessary for automatic speech recognition to use it as an input for the speech recognition system.

A static feature extracting portion 130 extracts a static feature vector for each frame by use of a prescribed method for extracting speech features. Included in the method for extracting speech features are MFCC (Mel-frequency cepstrum coefficients), PLP (perceptual linear prediction), GTCC (Gammatone Cepstral Coefficients), ZCPA (Zero-Crossings with Peak Amplitudes), and the like. A temporal buffer 140 stores a time array of the static feature vectors for extracting a dynamic feature vector.

A delta/double-delta extracting portion 150 extracts delta or double-delta information as the dynamic feature vector from the time array of static feature vectors stored in the temporal buffer 140. The delta and the double-delta represent a time variant feature of the time array of static feature vectors as a velocity and an acceleration, respectively. A feature combining portion 160 combines the static feature vector and the dynamic feature vector to configure a single feature vector stream. For example, a single feature vector stream is constituted with static+delta+double-delta.

### SUMMARY

Since a time variant characteristic of a static feature vector in a conventional method for extracting features for speech recognition is represented as a velocity or an acceleration, which is a linear variance of orientation, a characteristic of speech signals varying complicatedly and variously as shown in FIG. 2 cannot be reflected properly.

The present invention provides an apparatus and a method for extracting features for speech recognition that can represent the complex and diverse variance of speech signals effectively.

An apparatus for extracting features for speech recognition in accordance with the present invention includes: a frame forming portion configured to separate input speech signals in frame units having a prescribed size; a static feature extracting portion configured to extract a static feature vector for each frame of the speech signals; a dynamic feature extracting portion configured to extract a dynamic feature vector representing a temporal variance of the extracted static feature vector by use of a basis function or a basis vector; and a feature vector combining portion configured to combine the extracted static feature vector with the extracted dynamic feature vector to configure a feature vector stream.

The dynamic feature extracting portion can use a cosine basis function as the basis function. Here, the dynamic feature extracting portion can include: a DCT portion configured to perform a DCT (discrete cosine transform) for a time array of the extracted static feature vectors to compute DCT components; and a dynamic feature selecting portion configured to select some of the DCT components having a high correlation with a variance of the speech signal out of the DCT components as the dynamic feature vector. Here, the dynamic feature selecting portion can select a low frequency component excluding a DC component out of the DCT components as the dynamic feature vector, and specifically at least one of a first to third DCT components can be selected as the dynamic feature vector.

The dynamic feature extracting portion can use a basis vector pre-obtained through principal component analysis as the basis vector. Here, the dynamic feature extracting portion can include: a principal component analysis portion configured to perform principal component analysis for a time array of the extracted static feature vectors to extract a principal component; and a dynamic feature selecting portion configured to select some of the principal components having a high correlation with a variance of the speech signal out of the extracted principal components as the dynamic feature vector.

The dynamic feature extracting portion can also use a basis vector pre-obtained through independent component analysis as the basis vector. Here, the dynamic feature extracting portion can include: an independent component analysis portion configured to perform independent component analysis for a time array of the extracted static feature vectors to extract an independent component; and a dynamic feature selecting portion configured to select some of the independent components having a high correlation with a variance of the speech signal out of the extracted independent components as the dynamic feature vector.

The dynamic feature extracting portion can also use a basis vector pre-obtained through eigen vector analysis as the basis vector. Here, the dynamic feature extracting portion can include: an eigen vector analysis portion configured to perform eigen vector analysis for a time array of the extracted static feature vectors to extract an eigen vector component; and a dynamic feature selecting portion configured to select some of the eigen vector components having a high correlation with a variance of the speech signal out of the extracted eigen vector components as the dynamic feature vector.

A method for extracting features for speech recognition in accordance with the present invention includes: separating input speech signals in frame units having a prescribed size; extracting a static feature vector for each frame of the speech signals; extracting the dynamic feature vector representing a temporal variance of the extracted static feature vector; and combining the extracted static feature vector with the extracted dynamic feature vector to configure a feature vector stream.

The extracting of the dynamic feature vector can use a cosine basis function as the basis function. Here, in the step of extracting the dynamic feature vector, a DCT (discrete cosine transform) can be performed for a time array of the extracted static feature vectors to compute DCT components, and some of the DCT components having a high correlation with a variance of the speech signal out of the DCT components can be selected as the dynamic feature vector. Here, in the step of extracting the dynamic feature vector, a low frequency component excluding a DC component out of the DCT components can be selected as the dynamic feature vector, and specifically at least one of a first to third DCT components can be selected as the dynamic feature vector.

In the step of extracting the dynamic feature vector, a basis vector pre-obtained through principal component analysis can be used as the basis vector.

In the step of extracting the dynamic feature vector, a basis vector pre-obtained through independent component analysis can be used as the basis vector.

In the step of extracting the dynamic feature vector, a basis vector pre-obtained through eigen vector analysis can be used as the basis vector.

### BRIEF DESCRIPTION OF THE DRAWINGS

FIG. 1 shows a structure of a conventional apparatus for extracting features for speech recognition.

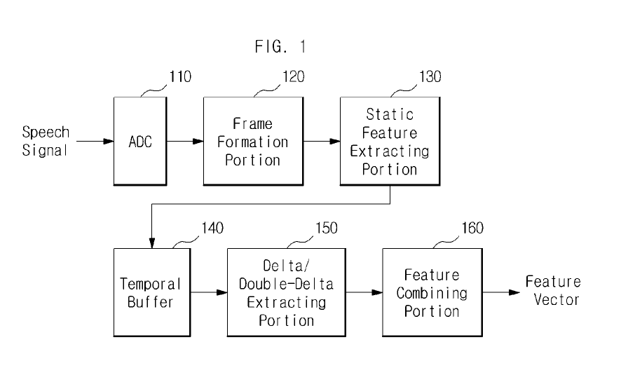

FIG. 2 shows a characteristic of speech signals varying complicatedly and diversely.

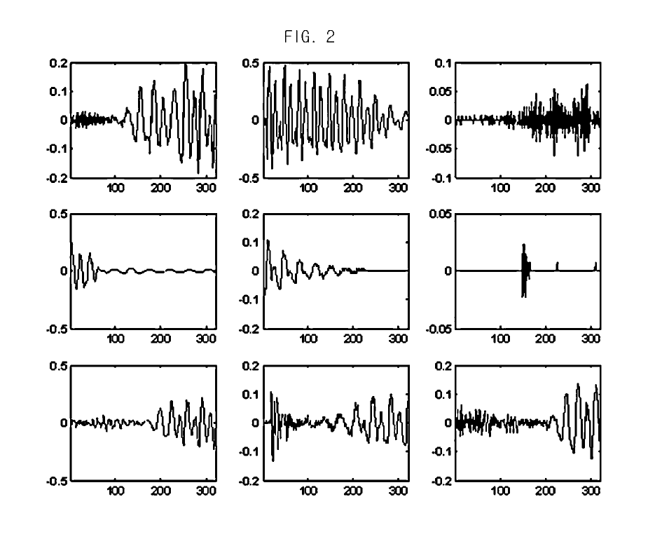

FIG. 3 shows a structure of an apparatus for extracting features for speech recognition in accordance with an embodiment of the present invention.

FIG. 4 shows a structure of an apparatus for extracting features in accordance with a first embodiment of the present invention.

FIG. 5 shows an example of types of cosine functions used as a basis function.

FIG. 6 shows a structure of an apparatus for extracting features in accordance with a second embodiment of the present invention.

FIG. 7 shows a structure of an apparatus for extracting features in accordance with a third embodiment of the present invention.

FIG. 8 shows a structure of an apparatus for extracting features in accordance with a fourth embodiment of the present invention.

FIG. 9 shows a flow diagram of a method for extracting features for speech recognition in accordance with an embodiment of the present invention.

### DETAILED DESCRIPTION

Hereinafter, certain embodiments of the present invention will be described in detail with reference to the drawings. In the following description and the accompanying drawings, substantially identical elements will be represented by identical reference numerals, respectively, and will not be redundantly described. Moreover, when describing certain known relevant functions or configuration is determined to distract the point of the present invention, such detailed description will be omitted.

In the embodiments of the present invention, a dynamic feature vector representing a temporal variance of a static feature vector is extracted by use of a basis function or a basis vector in order to represent characteristics of complex and diverse temporal variance of speech signals in detail. The basis function or the basis vector can be knowledge-based or data-based. The knowledge-based basis function includes a cosine function, and a discrete cosine transform (DCT) can be used when the cosine function is used for extracting the dynamic feature vector. Used for gaining the data-based basis vector can be principal component analysis (PCA), independent component analysis (ICA), and eigen vector analysis. Using the data-based basis vector obtained through a learning based on various speech signals, a more detailed variation of the speech signals can be rendered. In the embodiments of the present invention, the dynamic feature vector is extracted through a signal analysis technique using the basis function or the basis vector. Specifically, signal components are extracted through the signal analysis technique using the basis function or the basis vector, and some signal components suitable for rendering a temporal variance of the speech signal out of the extracted signal components are used as the dynamic feature vector. The performance of a speech recognition system can be improved by combining the dynamic feature vector with the static feature vector to create a feature vector stream and using the feature vector stream as an input for the speech recognition system.

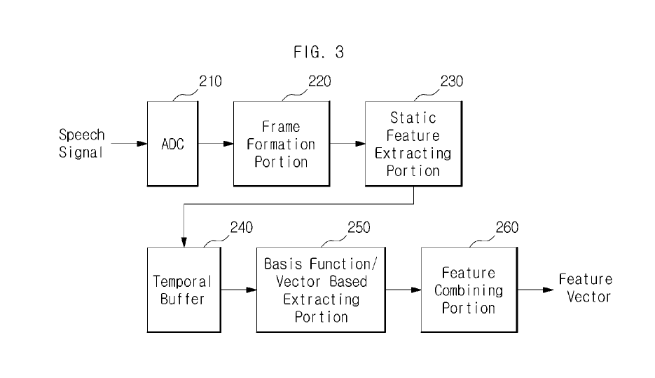

FIG. 3 shows a structure of an apparatus for extracting features for speech recognition in accordance with an embodiment of the present invention. The apparatus for extracting features in accordance with the present embodiment includes an analog digital converter 210, a frame formation portion 220, a static feature extracting portion 230, a temporal buffer 240, a basis function/vector based dynamic feature extracting portion 250, and a feature combining portion 260.

The analog digital converter 210 is configured to transform inputted analog speech signals to digital signals. The frame formation portion 220 is configured to divide consecutive digital speech signals in frame units having, for example, the frame shift size of 10 ms and the frame size of 29˜25 ms. The static feature extracting portion 230 is configured to extract a static feature vector for each frame by use of a prescribed method for extracting speech features. Used for the method for extracting speech features can be MFCC (Mel-frequency cepstrum coefficients), PLP (perceptual linear prediction), GTCC (Gammatone Cepstral Coefficients), ZCPA (Zero-Crossings with Peak Amplitudes), and the like. The temporal buffer 240 is configured to store a time array of the static feature vectors in order to extract a dynamic feature vector, which will be described later.

The basis function/vector based dynamic feature extracting portion 250 is configured to extract the dynamic feature vector representing a temporal variance of the static feature vector from the time array of the static feature vectors by use of a basis function or a basis vector. Here, used for the basis function or the basis vector can be a cosine function, a basis vector pre-obtained through independent component analysis, a basis vector pre-obtained through principal component analysis, or a basis vector pre-obtained through eigen vector analysis.

The feature combining portion 260 combines the extracted static feature vector and the dynamic feature vector to configure a single feature vector stream.

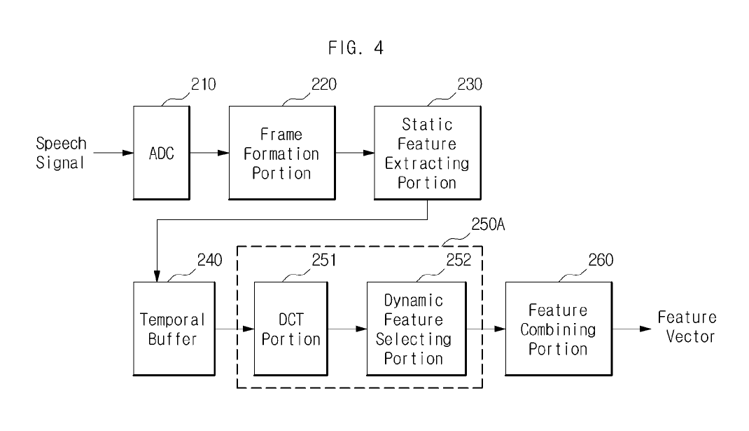

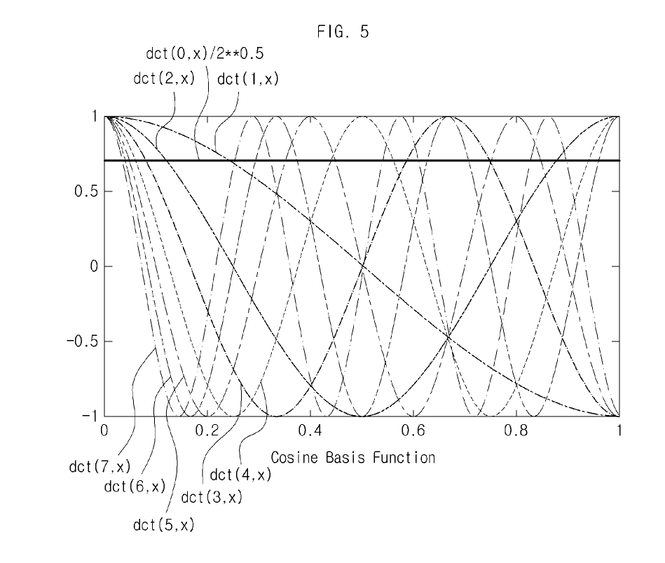

FIG. 4 shows a structure of an apparatus for extracting features in accordance with a first embodiment of the present invention. A basis function/vector based dynamic feature extracting portion 250A in the present embodiment uses a cosine function as a basis function, and is constituted with a DCT portion 251 and a dynamic feature selecting portion 252. FIG. 5 shows an example of types of cosine functions used as the basis function.

The DCT portion 251 is configured to perform a DCT (discrete cosine transform) for a time array of static feature vectors stored in a temporal buffer 240 and computes DCT components. That is, the DCT portion 251 computes a variance rate of the cosine basis function component from the time array of the static feature vectors.

The dynamic feature selecting portion 252 is configured to select some of the DCT components having a high correlation with a variance of the speech signal among the computed DCT components as a dynamic feature vector. Here, the DCT component having a high correlation with a variance of the speech signal can be a low frequency component excluding a DC (direct current) component. Specifically, a first to third DCT components excluding a DC component can be selected. For example, selected can be a first DCT component, or a first DCT component and a second DCT component, or a first to third DCT components.

Therefore, through a feature combining portion 260, a static feature vector extracted from a static feature extracting portion 230 and the DCT component selected from the dynamic feature selecting portion 252 are combined to configure a single feature vector stream.

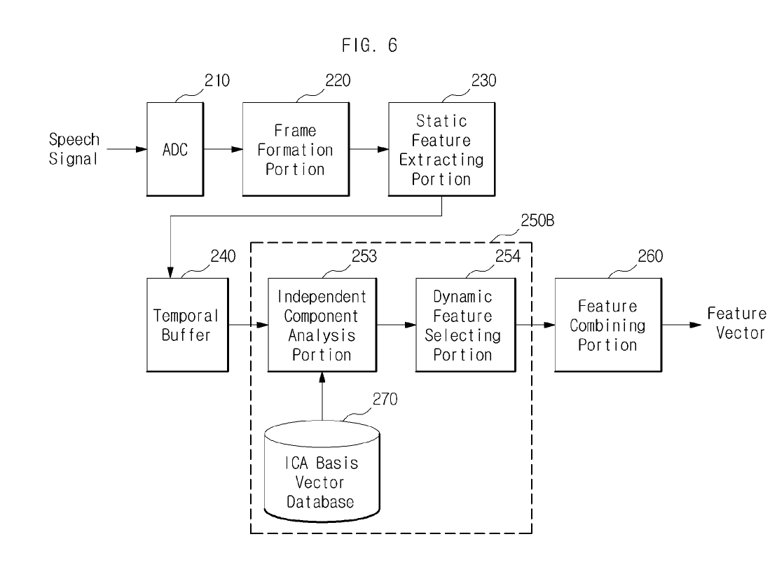

FIG. 6 shows a structure of an apparatus for extracting features in accordance with a second embodiment of the present invention. A basis function/vector based dynamic feature extracting portion 250B of the present embodiment uses a basis vector pre-obtained through independent component analysis as a basis vector, and is constituted with an independent component analysis portion 253, a dynamic feature selecting portion 254, and ICA basis vector database 270.

Stored in the ICA basis vector database 270 are ICA basis vectors pre-obtained through independent component analysis learning based on feature vectors of various speech signals.

The independent component analysis portion 253 is configured to perform independent component analysis with the stored ICA basis vectors for a time array of static feature vectors stored in a temporal buffer 240 and extract the independent components of the time array of static feature vectors.

The dynamic feature selecting portion 254 is configured to select some of independent components having a high correlation with a variance of the speech signal among the extracted independent components. For this, a degree of the independent components having a high correlation with a variance of the speech signal can be pre-defined.

Therefore, through a feature combining portion 260, a static feature vector extracted from a static feature extracting portion 230 and the independent component selected from the dynamic feature selecting portion 254 are combined to configure a single feature vector stream.

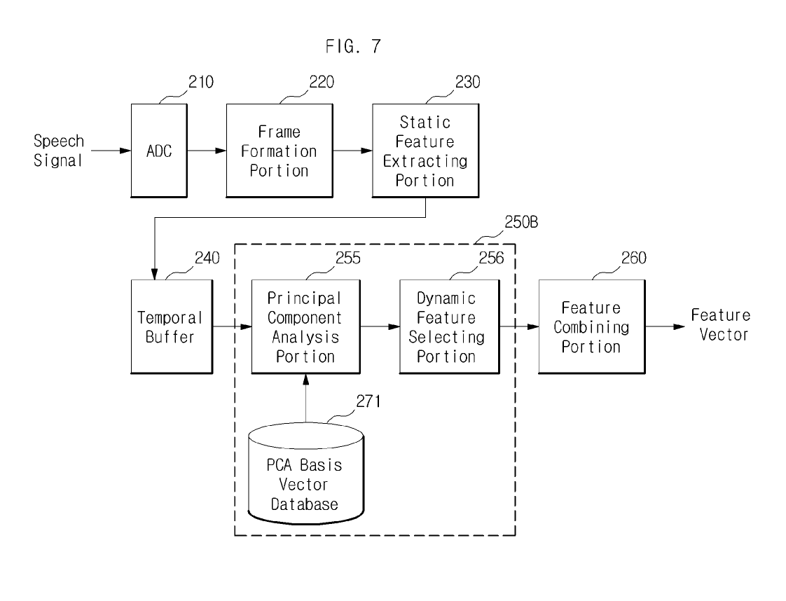

FIG. 7 shows a structure of an apparatus for extracting features in accordance with a third embodiment of the present invention. A basis function/vector based dynamic feature extracting portion 250C of the present embodiment uses a basis vector pre-obtained through principal component analysis as a basis vector, and may include a principal component analysis portion 255, a dynamic feature selecting portion 256, and a PCA basis vector database 271.

Stored in the PCA basis vector database 271 are PCA basis vectors pre-obtained through principal component analysis learning based on feature vectors of various speech signals.

The principal component analysis portion 255 is configured to perform principal component analysis with the stored PCA basis vectors for a time array of static feature vectors stored in a temporal buffer 240 and extract the principal components of the time array of static feature vectors.

The dynamic feature selecting portion 256 is configured to select some of principal components having a high correlation with a variance of the speech signal among the extracted principal components. For this, a degree of the principal components having a high correlation with a variance of the speech signal can be pre-defined.

Therefore, through a feature combining portion 260, a static feature vector extracted from a static feature extracting portion 230 and the principal component selected from the dynamic feature selecting portion 254 are combined to configure a single feature vector stream.

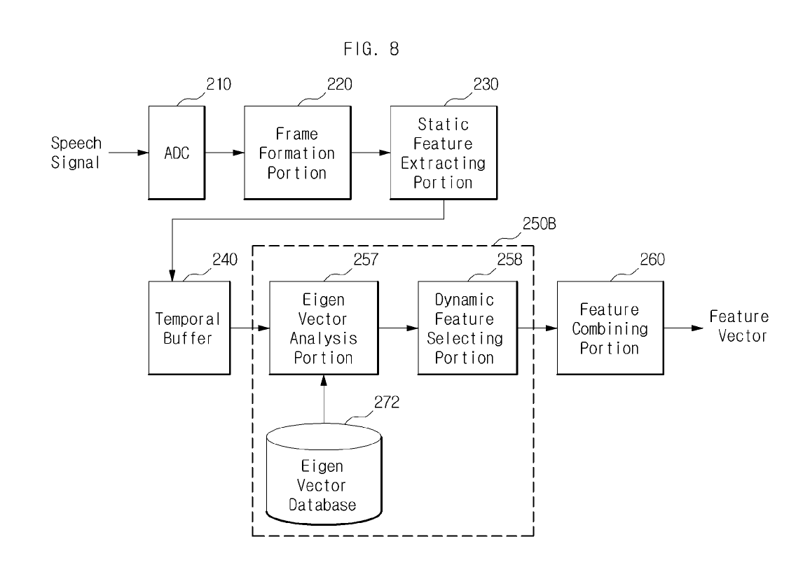

FIG. 8 shows a structure of an apparatus for extracting features in accordance with a fourth embodiment of the present invention. A basis function/vector based dynamic feature extracting portion 250D of the present embodiment uses a basis vector pre-obtained through eigen vector analysis as a basis vector, and is constituted with an eigen vector analysis portion 257, a dynamic feature selecting portion 258, and eigen vector database 272.

Stored in the eigen vector database 272 are eigen vectors pre-obtained through eigen vector analysis learning based on feature vectors of various speech signals.

The eigen vector analysis portion 257 is configured to perform eigen vector analysis with the stored eigen vectors for a time array of static feature vectors stored in a temporal buffer 240 and extract the eigen vector components of the time array of static feature vectors.

The dynamic feature selecting portion 258 is configured to select some of eigen vector components having a high correlation with a variance of the speech signal among the extracted eigen vector components. For this, a degree of the eigen vector components having a high correlation with a variance of the speech signal can be pre-defined.

Therefore, through a feature combining portion 260, a static feature vector extracted from a static feature extracting portion 230 and the eigen vector component selected from the dynamic feature selecting portion 254 are combined to configure a single feature vector stream.

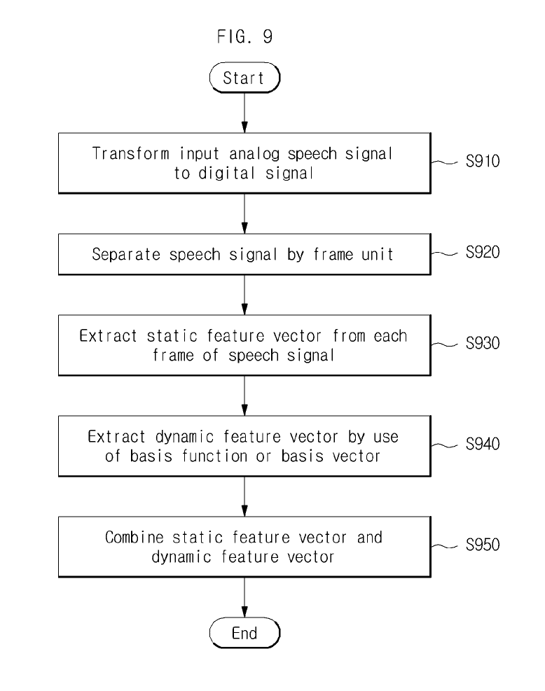

FIG. 9 shows a flow diagram of a method for extracting features for speech recognition in accordance with an embodiment of the present invention. The method for extracting speech features in accordance with the present embodiment includes steps processed in the above-described apparatus for extracting speech features. Therefore, despite omission hereinafter, the description about the apparatus for extracting speech features shall be equally applied to the method for extracting speech features in accordance with the present embodiment.

In step S910, the apparatus for extracting speech features transforms inputted analog speech signals to digital signals.

In step S920, the apparatus for extracting speech features divides the speech signals transformed to digital signals in frame units having a frame shift size of 10 ms and a frame size of 20˜25 ms.

In step S930, the apparatus for extracting speech features extracts a static feature vector for each frame of the speech signals by use of a prescribed method for extracting speech features. The extracted time array of static feature vectors is stored in a temporal buffer for extracting a dynamic feature vector.

In step S940, the apparatus for extracting speech features extracts the dynamic feature vector representing a temporal variance of the static feature vector from the time array of static feature vectors by use of a basis function or a basis vector.

In accordance with an embodiment, the apparatus for extracting speech features uses a cosine basis function as a basis function, in step S940. Here, the apparatus for extracting speech features performs a DCT (discrete cosine transform) for the time array of static feature vectors to compute DCT components, and selects some of DCT components having a high correlation with a variance of the speech signal among the computed DCT components as the dynamic feature vector.

In accordance with another embodiment, the apparatus for extracting speech features uses a basis vector pre-obtained through principal component analysis as a basis vector, in step S940. Here, the apparatus for extracting speech performs principal component analysis for the time array of static feature vectors to extract principal components, and selects some of principal components having a high correlation with a variance of the speech signal among the extracted principal components as a dynamic feature vector.

In accordance with yet another embodiment, the apparatus for extracting speech features uses a basis vector pre-obtained through independent component analysis as a basis vector, in step S940. Here, the apparatus for extracting speech performs independent component analysis for the time array of static feature vectors to extract independent components, and selects some of independent components having a high correlation with a variance of the speech signal among the extracted independent components as a dynamic feature vector.

In accordance with still another embodiment, the apparatus for extracting speech features uses a basis vector pre-obtained through eigen vector analysis as a basis vector, in step S940. Here, the apparatus for extracting speech performs eigen vector analysis for the time array of static feature vectors to extract eigen vector components, and selects some of eigen vector components having a high correlation with a variance of the speech signal among the extracted eigen vector components as a dynamic feature vector.

In step S950, the apparatus for extracting speech features combines the extracted static feature vector and the dynamic feature vector to configure a single vector stream.

The above-described embodiments of the present invention can be written as a computer-executable program, and can be realized in a general purpose digital computer operating the program by use of a computer-readable recording medium. The computer-readable recording medium includes a magnetic recording medium, such as ROM, Floppy Disk, Hard Disk, etc., and optical recording medium, such as CD-ROM, DVD, etc.

Although certain embodiments of the present invention have been described, they are described for illustrative purposes only and shall not restrict the invention. It shall be appreciated that various permutations are possible by those who are ordinarily skilled in the art to which the present invention pertains without departing from the intrinsic features of the present embodiment. The scope of the present invention shall be understood by the claims appended below, rather than by the above description. Any differences residing in the equivalent scope shall be deemed to be included in the present invention.

What is claimed is:

1. An apparatus for extracting features for speech recognition, comprising:
a frame forming portion configured to separate inputted speech signals in frame units having a prescribed size;
a static feature extracting portion configured to extract a static feature vector for each frame of the speech signals;
a dynamic feature extracting portion configured to extract a dynamic feature vector representing a temporal variance of the extracted static feature vector by use of a basis function or a basis vector; and
a feature vector combining portion configured to combine the extracted static feature vector with the extracted dynamic feature vector to configure a feature vector stream.

2. The apparatus of claim 1, wherein the dynamic feature extracting portion is configured to use a cosine basis function as the basis function.

3. The apparatus of claim 2, wherein the dynamic feature extracting portion comprises:
a DCT portion configured to perform a DCT (discrete cosine transform) for a time array of the extracted static feature vectors to compute DCT components; and
a dynamic feature selecting portion configured to select some of the DCT components having a high correlation with a variance of the speech signal out of the DCT components as the dynamic feature vector.

4. The apparatus of claim 3, wherein the dynamic feature selecting portion is configured to select a low frequency component excluding a DC component out of the DCT components as the dynamic feature vector.

5. The apparatus of claim 4, wherein the dynamic feature selecting portion is configured to select at least one of a first to third DCT components as the dynamic feature vector.

6. The apparatus of claim 1, wherein the dynamic feature extracting portion is configured to use a basis vector pre-obtained through principal component analysis as the basis vector

7. The apparatus of claim 6, wherein the dynamic feature extracting portion comprises:
a principal component analysis portion configured to perform principal component analysis for a time array of the extracted static feature vectors to extract principal components; and
a dynamic feature selecting portion configured to select some of the principal components having a high correlation with a variance of the speech signal out of the extracted principal components as the dynamic feature vector.

8. The apparatus of claim 1, wherein the dynamic feature extracting portion is configured to use a basis vector pre-obtained through independent component analysis as the basis vector.

9. The apparatus of claim 8, wherein the dynamic feature extracting portion comprises:
an independent component analysis portion configured to perform independent component analysis for a time array of the extracted static feature vectors to extract independent components; and
a dynamic feature selecting portion configured to select some of the independent components having a high correlation with a variance of the speech signal out of the extracted independent components as the dynamic feature vector.

10. The apparatus of claim 1, wherein the dynamic feature extracting portion is configured to use a basis vector pre-obtained through eigen vector analysis as the basis vector.

11. The apparatus of claim 10, wherein the dynamic feature extracting portion comprises:
an eigen vector analysis portion configured to perform eigen vector analysis for a time array of the extracted static feature vectors to extract eigen vector components; and
a dynamic feature selecting portion configured to select some of the eigen vector components having a high correlation with a variance of the speech signal out of the extracted eigen vector components as the dynamic feature vector.

12. A method for extracting features for speech recognition, comprising:
separating inputted speech signals in frame units having a prescribed size;
extracting a static feature vector for each frame of the speech signals;
extracting a dynamic feature vector representing a temporal variance of the extracted static feature vector by use of a basis function or a basis vector; and
combining the extracted static feature vector with the extracted dynamic feature vector to configure a feature vector stream.

13. The method of claim 12, wherein, in the step of extracting the dynamic feature vector, a cosine basis function is used as the basis function.

14. The method of claim 13, wherein, in the step of extracting the dynamic feature vector, a DCT (discrete cosine transform) is performed for a time array of the extracted static feature vectors to compute DCT components, and some of the DCT components having a high correlation with a variance of the speech signal out of the DCT components are used as the dynamic feature vector.

15. The method of claim 14, wherein, in the step of extracting the dynamic feature vector, a low frequency component excluding a DC component out of the DCT components is used as the dynamic feature vector.

16. The method of claim 15, wherein, in the step of extracting the dynamic feature vector, at least one of a first to third DCT components is used as the dynamic feature vector.

17. The method of claim 12, wherein, in the step of extracting the dynamic feature vector, a basis vector pre-obtained through principal component analysis is used as the basis vector.

18. The method of claim 12, wherein, in the step of extracting the dynamic feature vector, a basis vector pre-obtained through independent component analysis is used as the basis vector.

19. The method of claim 12, wherein, in the step of extracting the dynamic feature vector, a basis vector pre-obtained through eigen vector analysis is used as the basis vector.
